(19) United States
(12) Patent Application Publication
(10) Pub. No.: US 2006/0072594 A1
(43) Pub. Date: Apr. 6, 2006

(54) Gaming environment including a virtual network

(76) Inventor: Vikram Swamy, Chicago, IL (US)

Correspondence Address: Schwegman, Lundberg, Woessner & Kluth, P.A., P.O. Box 2938, Minneapolis, MN, 55402, US

(21) Appl. No.: 11/244,328

(22) Filed: Oct. 4, 2005

Related U.S. Application Data
(60) Provisional application No. 60/522,473, filed on Oct. 4, 2004.

(51) Int. Cl. H04L 12/56

(52) U.S. Cl. 370/409

(57) ABSTRACT

Systems and methods provide a gaming machine and server network environment that may be configured into one or more VLANs. The VLANs may be static VLANs, dynamic VLANs, MAC address based VLANs. In addition, the VLANs may be segregated based on a service provided on the VLAN such as a management service, a tournament service, or a progressive service. Further, IP multicast techniques may be used to support services on the gaming network.

### RELATED APPLICATION

This application claims priority under 35 U.S.C. 119(e) from U.S. Provisional Patent Application Ser. No. 60/522,473, filed Oct. 4, 2004, entitled “GAMING ENVIRONMENT INCLUDING A VIRTUAL NETWORK” which is hereby incorporated by reference.

### FIELD

The present invention relates generally to gaming machine environments and systems, and more particularly to providing virtual networks of gaming systems.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2004, WMS Gaming, Inc. All Rights Reserved.

### BACKGROUND

Gaming devices were once standalone systems that did not communicate with other devices or systems. It is becoming more and more common for gaming devices to be connected to a network in order to provide more services and features on the gaming device. For example, a progressive service where individual gaming machines can contribute a portion of each wager to a shared pot that can be won by a player using a participating gaming device are quite popular. The gaming device may be coupled via a network to a progressive service that manages the pot. In addition, management services may be provided using a network. For example, a gaming device coupled to the network may report amounts wagered, payouts, bonus round executions etc. to the management service. Thus the gaming establishment can provide popular services and features and also gather an analyze data regarding the play of gaming devices on the network.

While coupling gaming systems and device together on a network provide advantages to a gaming establishment, several issues remain. First, multicast data must typically be sent over each segment in the, regardless of whether a system desiring the multicast data exists on the segment or not. This can lead to wasted network bandwidth on such segments.

Second, there can be security issues. As more and more devices and systems are coupled to the network, it may become easier for a user (authorized or not) of such systems to access network data that they should not have a legitimate need or privilege to access.

In view of the above, there is a need in the art for the present invention.

### SUMMARY

Systems and methods provide a gaming machine and server network environment that may be configured into one or more VLANs (Virtual Local Area Networks). The VLANs may be static VLANs, dynamic VLANs, MAC address based VLANs. In addition, the VLANs may be segregated based on a service provided on the VLAN such as a management service, a tournament service, or a progressive service. Further, IP multicast techniques may be used to support services on the gaming network.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a perspective view of a gaming machine embodying the present invention;

FIG. 2 is a block diagram of a gaming control system suitable for operating the gaming machine in FIG. 1;

FIG. 3 is a block diagram of a gaming network having virtual networks according to varying embodiments of the invention;

FIG. 4 is a block diagram of a gaming network operable to send and receive broadcast data according to varying embodiments of the invention; and

FIG. 5 is a flowchart illustrating a method for operating a gaming system according to embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

### Operating Environment

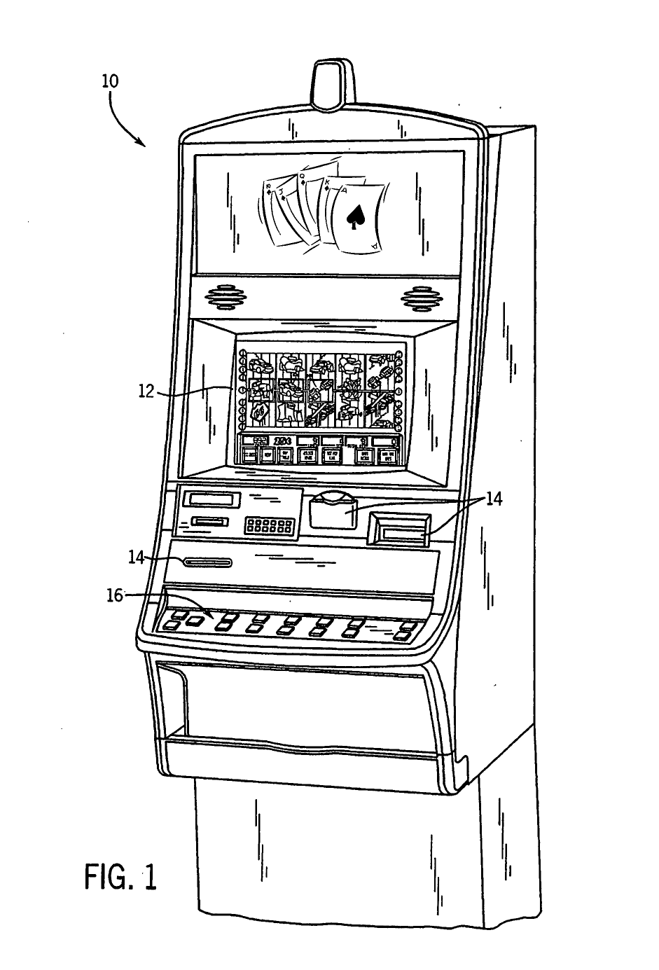

FIG. 1 illustrates an exemplary gaming machine 10, also referred to as a Video Lottery Terminal (VLT), in which embodiments of the invention may be implemented. In some embodiments, gaming machine 10 is operable to conduct a wagering game such as mechanical or video slots, poker, keno, bingo, or blackjack. If based in video, the gaming machine 10 includes a video display 12 such as a cathode ray tube (CRT), liquid crystal display (LCD), plasma, or other type of video display known in the art. A touch screen preferably overlies the display 12. In the illustrated embodiment, the gaming machine 10 is an “upright” version in which the display 12 is oriented vertically relative to a player. Alternatively, the gaming machine may be a “slant-top” version in which the display 12 is slanted at about a thirty-degree angle toward the player. Still further, the gaming machine may be housed in a wall mounted or other vertically mounted cabinet. In yet further embodiments, the gaming machine may be housed in a portable or handheld device. In such devices, the user interface elements (buttons, screen etc.) may be scaled down or eliminated in order to fit the elements into an appropriate housing for a handheld or portable gaming machine.

The gaming machine 10 includes a plurality of possible credit receiving mechanisms 14 for receiving credits to be used for placing wagers in the game. The credit receiving mechanisms 14 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money.

In some embodiments, the gaming machine 10 includes a user interface comprising a plurality of push-buttons 16, the above-noted touch screen, and other possible devices. The plurality of push-buttons 16 may, for example, include one or more “bet” buttons for wagering, a “play” button for commencing play, a “collect” button for cashing out, a help” button for viewing a help screen, a “pay table” button for viewing the pay table(s), and a “call attendant” button for calling an attendant. Additional game specific buttons may be provided to facilitate play of the specific game executed on the machine. The touch screen may define touch keys for implementing many of the same functions as the push-buttons. Other possible user interface devices include a keyboard and a pointing device such as a mouse or trackball.

In some embodiments, gaming machine 10 includes a top box 40. Top box 40 may contain a video display, a mechanical display, or a diorama display that supplements display 12. For example, the display in top box 40 may be a wheel such as a rotating wheel, mechanical dice, a board for a board game, or other such display.

A processor controls operation of the gaming machine 10. In response to receiving a wager and a command to initiate play, the processor randomly selects a game outcome from a plurality of possible outcomes and causes the display 12 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the processor awards the player with a number of credits associated with the winning outcome.

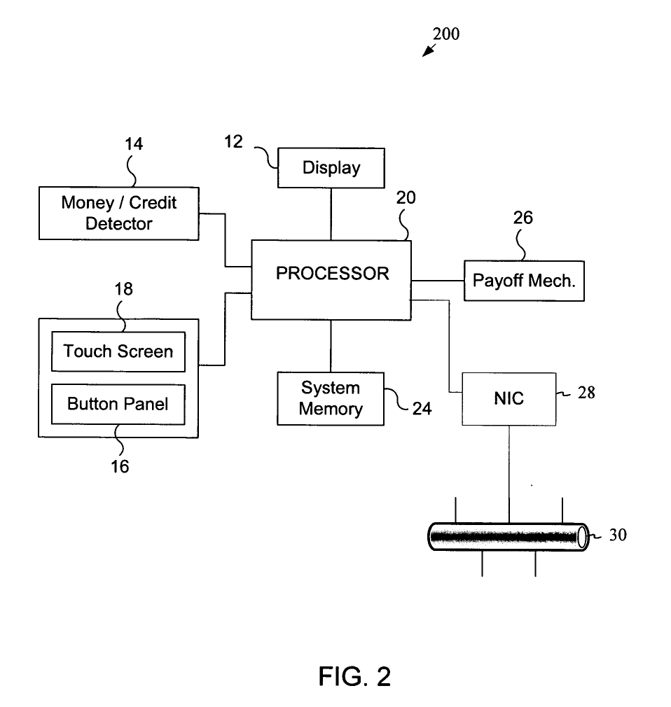

FIG. 2 is a block diagram of a control system suitable for operating the gaming machine. Money/credit detector 22 signals a processor 20 when a player has inserted money, tickets, tokens, cards or other mechanism for obtaining credits for plays on the gaming machine. Using a button panel 16 and/or a touch screen 18 (also see FIG. 1), the player may select any variables associated with the wagering game and place his/her wager to purchase a play of the game. In a play of the game, the processor 20 generates at least one random event using a random number generator (RNG) and provides an award to the player for a winning outcome of the random event. Alternatively, the random event may be generated by a remote computer using an RNG or pooling schema and then transmitted to the gaming machine. The processor 20 operates the display 12 to represent the random event(s) and outcome(s) in a visual form that can be understood by the player. In addition to the processor 20, the control system may include one or more additional slave control units for operating the display 12 and any secondary displays.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure. A payoff mechanism 26 is operable in response to instructions from the processor 20 to award a payoff to the player. The payoff may, for example, be in the form of a number of credits. The number of credits is determined by one or more math tables stored in the system memory 24.

Network Interface Card (NIC) 28 is coupled to the control system and is operable to send and receive data packets on a network 30 that includes gaming machines 10 and other gaming related servers and systems. In some embodiments of the invention, NIC 28 supports send and receiving VLAN packets. In particular embodiments, the VLAN packets include a MAC (Media Access and Control) header that provides a four byte data field that includes a VLAN identifier and priority data. Typically NIC 28 on a gaming machine 10 will support the same VLAN implementation as that on the NICs of the various other servers and systems that coupled to gaming network 30.

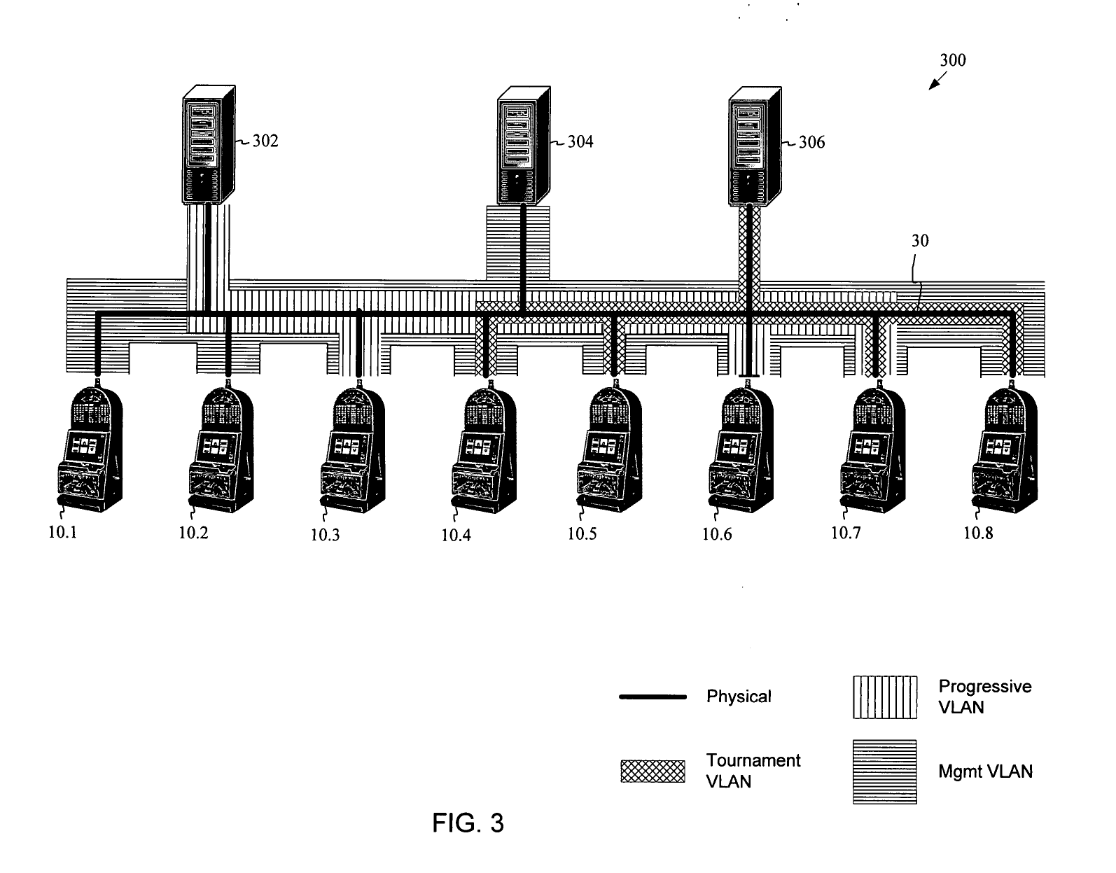

FIG. 3 is a block diagram of a gaming network having virtual networks according to varying embodiments of the invention. In some embodiments, network environment 300 includes one or more gaming machines 10 and one or more servers 302, 304 and 306 communicably coupled to network 30.

Progressive server 302 comprises a server that maintains a progressive game in which a plurality of gaming machines participates. Progressive jackpots are jackpots that increase progressively as long as game play continues without reward of the jackpot. In a progressive gaming system, two or more gaming machines are linked together, and the progressive jackpot is increased more rapidly based on the collective play at separate machines. Each successive losing play (that is, play that does not result in award of the jackpot) grows the jackpot, creating a greater incentive for users to continue play. A winning play, results in award of the jackpot to the winning player and a reset of the jackpot to a smaller value for further increase and eventual award to a winning player.

Management server 304 comprises a server that provides one or more of management, event reporting and/or accounting services for gaming machines on gaming network 30.

Tournament server 306 comprises a server that manages and maintains tournament play among a plurality of gaming machines. A tournament is a multiplayer game in which the players can enter and compete in the tournament played on each player's respective slot machine.

Network 30 may be any type of network capable of communicably coupling gaming machines and server. Network 30 may be a wired network, a wireless network, or a combination of both wired and wireless network segments. In some embodiments, network 30 may be an Ethernet based local area network. In alternative embodiments, the network may be a token-ring based network. Although illustrated as a single segment in FIG. 3, the network may comprise multiple network segments with the segments being connected by one or more bridges, switches, and/or routers.

One or more VLANs may be provided on network 30. In some embodiments, the VLANs substantially conform to the IEEE 802.1p standard for VLANs. In alternative embodiments, the VLANs substantially conform to the IEEE 802.1q standard. However, the embodiments of the invention are not limited to any particular VLAN standard.

Further, the one or more VLANs may comprise various types of VLANs. For example, in some embodiments, the VLAN may be a static VLAN (also known as port-based VLAN). In this type of VLAN, ports on switches are assigned to VLANs. A gaming machine or server that attaches to the switch port will receive traffic destined for the VLAN or VLANs configured on the port.

In alternative embodiments, the VLANs may be dynamic VLANs. In these embodiments, the gaming machine or server dynamically subscribes to a VLAN using a VLAN registration protocol. In varying embodiments, the registration protocol may be the GARP (Generic Attribute Registration Protocol), GVRP (GARP VLAN Registration Protocol) or GMRP (GARP Multicast Registration Protocol) registration protocols.

In further alternative embodiments, the VLAN may be a MAC address based VLAN. In these embodiments, a switch, router or other network device is configured to dynamically assigns a port to a VLAN based on the MAC address of the gaming machine or server connected at the port.

In some embodiments, the VLANs are configured on the gaming network 30 according to a service type. In the exemplary embodiment illustrated in FIG. 3, the gaming machines, servers, and network devices (if any) such as switches, bridges or routers are configures to provide three VLANs, a management VLAN, a tournament VLAN, and a progressive VLAN.

Thus in the exemplary embodiment illustrated in FIG. 3, each of gaming machines 10.1-10.8 and management server 304 participate in a management VLAN in which management, event reporting and/or accounting traffic may be sent and received by the systems configured on the management VLAN. Gaming machines 10.3, 10.6 and 10.7 and progressive server 302 participate in a progressive VLAN where data for progressive games may be sent and received by the systems configured on the progressive VLAN. Finally, gaming machines 10.4, 10.6 and 10.7 along with tournament server 306 participate in a tournament VLAN in which tournament related data may be sent and received by the systems configured on the tournament VLAN.

As illustrated in the exemplary embodiments shown in FIG. 3, a gaming machine or server may participate in more than one VLAN at the same time. For example, gaming machine 10.7 participates in all three of the VLAN types shown in the exemplary embodiments.

It should be noted that while three VLANs having eight gaming machines and three servers are shown in FIG. 3, those of skill in the art will appreciate that various numbers of VLANs, gaming machines and servers may be combined or segmented into separate VLANs and that such combinations are within the scope of the embodiments of the invention. The embodiments are not limited to any particular number of VLANs, servers, or gaming machines.

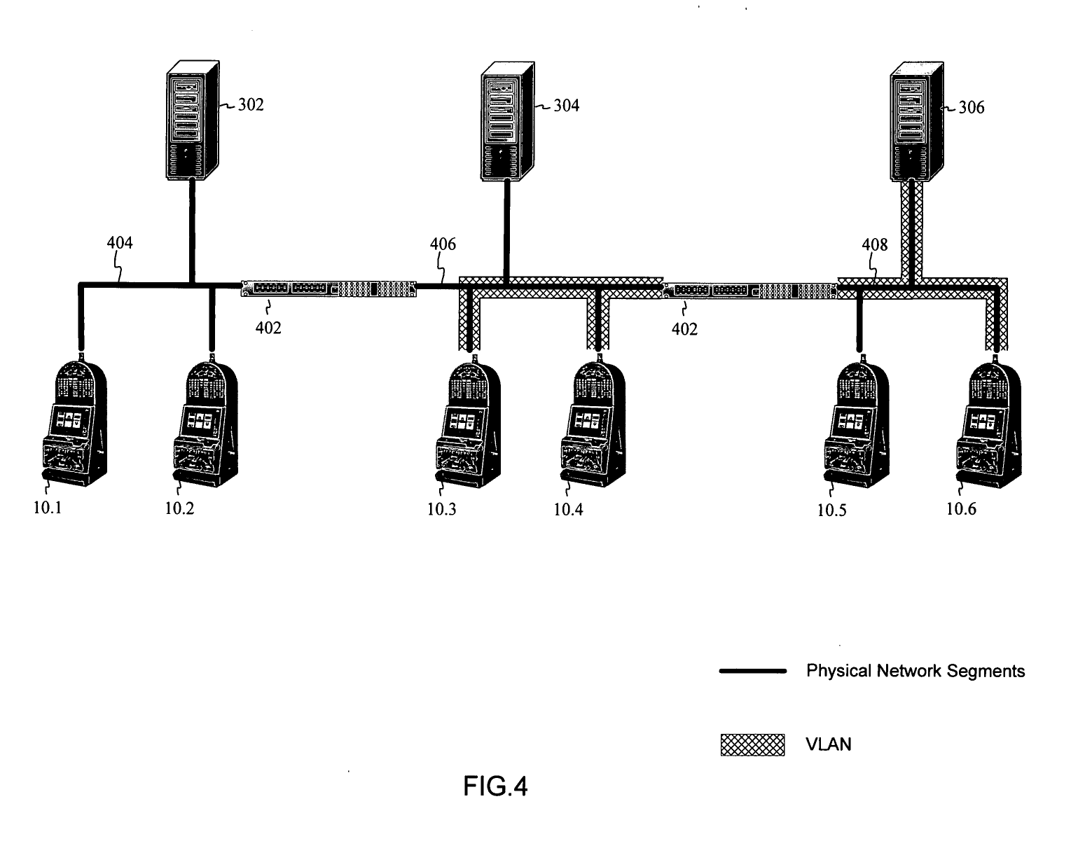

FIG. 4 is a block diagram of a gaming network operable to send and receive broadcast and/or multicast data according to varying embodiments of the invention. In some embodiments of the invention, servers and gaming machines participating on a gaming network 30 use IP multicast protocols to communicate data with one another. In some embodiments, IGMP (Internet Group Management Protocol) versions 1-3 or later developed versions may be used as the group management protocol. In addition, a multicast routing protocol such as DVMRP (Distance Vector Multicast Routing Protocol) may be used to multicast packets on network 30. In these embodiments, switches 402 and routers (not shown) on network 30 may support IGMP and/or DVMRP. In some embodiments, gaming machines and servers dynamically join and leave multicast groups. As noted above, the IGMP protocol may be used to support dynamic multicast group membership where members can dynamically join and leave multicast groups.

Servers on network 30 may use IP multicast to send data. For example, progressive server 302 may multicast the current progressive amount to machines participating in the progressive game. In these embodiments, progressive server 302 may advertise progressive amounts to a well-known multicast IP address, which may be an IP-Class D address. Gaming machines 10 that participate in the progressive game may send join messages (e.g. IGMP join messages) to an IGMP router to join the Multicast group identified by IP-Class multicast address. The router then forwards all traffic destined to the IP-Class D address on all interfaces on which it has received a join message (e.g. IGMP Join message) for the IP-Class D address. Conversely, a gaming machine or server may leave network multicast groups using IGMP messages.

Multicast messages may be used in other contexts besides progressive games. For example, gaming machines 10 that participate in a tournament game along with tournament server 306 may use the same mechanism to multicast tournament related messages to services and gaming machines that are participating in the tournament.

In some embodiments, VLANs may be used to contain broadcast and multicast traffic to particular segments in the gaming network. In the example illustrated in FIG. 4, gaming machines 10.3, 10.4 and 10.6 participate in a tournament with the assistance of tournament server 306. Switch 402 may be configured regarding details for the VLAN. Data for the tournament that is broadcast or multicast is limited to segments 406 and 408 by switch 402 because the VLAN only exists on these segments. Multicast or broadcast data for the VLAN is not sent to segment 404 because the VLAN does not extend to this segment in the exemplary embodiment illustrated in FIG. 4.

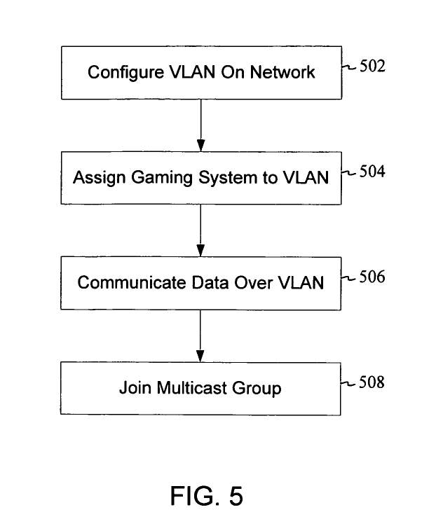

FIG. 5 is a flowchart illustrating methods for operating a gaming system according to embodiments of the invention. The methods may be performed within an operating environment such as that described above with reference to FIGS. 1-4 above. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from machine-readable media such as RAM, ROM, CD-ROM, DVD-ROM, hard disk, flash memory etc.). The methods illustrated in FIG. 5 are inclusive of the acts performed by an operating environment executing an exemplary embodiment of the invention.

The method begins by configuring a VLAN on a network (block 502). As noted above, the VLAN may conform to standards such as IEEE 802.1p and IEEE 802.1q.

Next, a gaming system (e.g. a server or gaming machine) is assigned to the VLAN (block 504). Various mechanisms may be used to assign a gaming system to a VLAN. For example, in some embodiments where the VLAN is a static VLAN, a gaming system is assigned to a VLAN based on a port on a switch. Ports on the switch are configured to participate in a particular VLAN. Any device coupled to the port thus becomes a node on the VLAN.

In alternative embodiments, a gaming system is assigned to a VLAN based on a MAC address of the gaming system. A switch or router is configured to assign devices to VLANs based on MAC addresses. When a device is coupled to the switch, the switch recognizes the MAC address of the device and determines which VLANs, if any, the device is assigned to.

In further alternative embodiments, the gaming system is assigned to one or more VLANs using a registration mechanism. As noted above, various registration protocols may be used. Examples of such registration protocols include GARP, GVRP and GMRP.

The gaming system may then communicate data (e.g. send and/or receive data) over the VLAN (block 506). In some embodiments, a network interface (NIC) is configured to recognize and decipher a VLAN length packet using a four byte field added to a standard MAC header. The four byte field includes an identifier for the VLAN and may also include priority data.

In some embodiments, a gaming system may participate in more than one VLAN. Further, in some embodiments, a VLAN is selected based on a service that is provided on the network. For example, a VLAN may be created to carry progressive service data. Gaming systems that wish to use the progressive service may be assigned to the “progressive” VLAN and communicate progressive data with one another. Systems not participating in the “progressive” VLAN will not be able to see the progressive data. Similarly, a gaming system may be assigned to a management VLAN intended for the communicate of management related data for the gaming network. Further, a system may be assigned to a tournament VLAN that carries data related a tournament game in which multiple gaming machines participate in a tournament. As noted above, a single gaming machine may participate in more than one VLAN.

In some embodiments, a gaming system may join a multicast group (block 508). Various protocols may be implemented to support multicasting. For example, in some embodiments, an IGMP protocol may be used. Additionally, a DVMRP protocol may be used. As noted above, services may use multicasting to send data to multiple machines participating in a VLAN. In the example progressive VLAN, progressive data may be multicast to multiple gaming machines simultaneously.

### CONCLUSION

Systems and methods for providing VLANs and multi-cast services on a gaming network have been disclosed. The systems and methods described provide advantages over previous systems. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description.

What is claimed is:

1. A networked gaming system comprising:
a plurality of gaming systems;
a network communicably coupling gaming systems; and
a VLAN (Virtual Local Area Network) established on the network, wherein at least a subset of the plurality of gaming systems are configured to communicate using the VLAN.

2. The gaming network system of claim 1, further comprising a switch having a plurality of ports.

3. The gaming network system of claim 2, wherein a subset of the ports on the switch are configured as part of the VLAN.

4. The gaming network system of claim 2, wherein the switch configures a port to be part of the VLAN based on a MAC (Media Access Control) address of a device communicably coupled to the port.

5. The gaming network system of claim 1, wherein network packets to be transmitted of the VLAN include a VLAN identifier and wherein a network interface configured to interpret the network packet including the VLAN identifier.

6. The gaming network system of claim 1, wherein the network includes a plurality of physical network segments and wherein network packets having a VLAN identifier are contained within a subset of the physical network segments, the subset comprising segments having at least one gaming system participating in the VLAN.

7. The gaming network system of claim 1, wherein network data for a gaming service is transmitted through the VLAN.

8. The gaming network system of claim 7, wherein the gaming service comprises a progressive service.

9. The gaming network system of claim 7, wherein the gaming service comprises a tournament service.

10. The gaming network system of claim 7, wherein the gaming service comprises a gaming management service.

11. A method for operating a gaming system, the method comprising:
configuring a VLAN on a network;
assigning a gaming system to the VLAN; and
communicating data by the gaming system over the VLAN.

12. The method of claim 11, wherein assigning the gaming system to a VLAN includes assigning based on a switch port coupling the gaming system to a switch.

13. The method of claim 11, wherein assigning the gaming system to a VLAN includes assigning based on a MAC address of the gaming system.

14. The method of claim 11, wherein assigning the gaming system to a VLAN includes configuring a network interface on the gaming system to recognize a VLAN identifier in a network data packet.

15. The method of claim 11, wherein assigning the gaming system to a VLAN includes subscribing by the gaming system to the VLAN.

16. The method of claim 15, wherein subscribing to the VLAN includes subscribing according to a protocol selected from the group consisting of GARP, GVRP and GMRP.

17. The method of claim 11, wherein communicating data includes sending or receiving multicast data.

18. The method of claim 17, wherein the multicast data conforms to the IGMP protocol.

19. The method of claim 17, wherein the multicast data conforms to the DVMRP protocol.

20. The method of claim 17, wherein the multicast data comprises data for a gaming service.

21. The method of claim 20, wherein the service comprises a progressive service.

22. The method of claim 20, wherein the service comprises a tournament service.

23. The method of claim 17, further comprising subscribing to a multicast group.

24. A computer-readable medium having computer executable instructions for performing a method for operating a gaming system, the method comprising:
configuring a VLAN on a network;
assigning a gaming system to the VLAN; and
communicating data by the gaming system over the VLAN.

25. The computer-readable medium of claim 24, wherein assigning the gaming system to a VLAN includes configuring a network interface on the gaming system to recognize a VLAN identifier in a network data packet.

26. The computer-readable medium of claim 24, wherein assigning the gaming system to a VLAN includes subscribing by the gaming system to the VLAN.

27. The computer-readable medium of claim 26, wherein subscribing to the VLAN includes subscribing according to a protocol selected from the group consisting of GARP, GVRP and GMRP.

28. The computer-readable medium of claim 24, wherein communicating data includes sending or receiving multicast data.

29. The computer-readable medium of claim 28, wherein the multicast data comprises data for a gaming service.

30. The computer-readable medium of claim 29, wherein the service comprises a progressive service.

31. The computer-readable medium of claim 24, further comprising subscribing to a multicast group.
